(19) United States
(12) Patent Application Publication
(10) Pub. No.: US 2006/0154052 A1
(43) Pub. Date: Jul. 13, 2006

(54) Soft magnetic material for manufacturing printed circuit boards

(75) Inventors: Eberhard Waffenschmidt, Aachen (DE); Eike Langkabel, Wegbeg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/561,860

(22) PCT Filed: Jun. 29, 2004
(86) PCT No.: PCT/IB04/51039

§ 371 Date: Dec. 21, 2005

(30) Foreign Application Priority Data
Jul. 3, 2003 (EP) 03101991.2

(51) Int. Cl. B32B 5/16; B32B 17/10

(52) U.S. Cl. 428/339; 428/323; 428/328

(57) ABSTRACT

The present invention relates to a soft magnetic material printed circuit boards. During the manufacturing of the printed magnetic circuit boards, the soft magnetic layer is used, such that it forms an integral part of the PCB after the manufacturing. In particular, the soft magnetic layers are formed such that, together with suitable circuit structures, an inductive component is formed. According to an aspect of the present invention, a polymer matrix of the soft magnetic layer is compatible to materials and/or processes used during the PCB manufacturing process.

The present invention relates to printed circuit boards and materials for the manufacturing of printed circuit boards. In particular, the present invention relates to a material for use in the manufacturing of printed circuit boards, to a printed circuit board and to a method of manufacturing printed circuit boards.

DE 101 39 707 A1 discloses a printed circuit board (PCB), including at least one di-electric layer, on which both side faces, capacitor electrodes are arranged opposite to each other in a first region. Furthermore, there are planar windings on the side faces in at least one second region adjacent to the first region. EP 1 282 143 A2 describes a method of forming a magnetic body.

However, the composition and the materials suggested in the DE 101 39 707 A1 are not compatible with the subsequent manufacturing of printed circuit boards. In such cases, the incompatible materials may cause defects in the printed circuit boards.

It is an object of the present invention to provide for an improved manufacturing of printed circuit boards.

According to an exemplary embodiment of the present invention as set forth in claim 1, the above object may be solved by a material for use in the manufacturing of printed circuit boards. The material, according to this exemplary embodiment of the present invention, comprises a polymer matrix and a soft magnetic powder. The polymer matrix is filled with the soft magnetic powder. In accordance with an aspect of this exemplary embodiment of the present invention, the polymer matrix is such that it is compatible to at least one of materials

comprised in printed circuit boards and processes used for the manufacturing of printed circuit boards.

In other words, according to this exemplary embodiment of the present invention, the polymer matrix (and thus the material) is adapted to the process for the manufacturing of the printed circuit board and/or the materials comprised in the printed circuit boards. Due to the compatibility with at least one of the materials and the process, the material according to this exemplary embodiment of the present invention may advantageously be integrated into the printed circuit board. By the integration of this material according to the present invention having soft magnetic properties, components, such as inductive components may be fully integrated into the printed circuit board and may become an integral part of the printed circuit board (PCB).

According to another exemplary embodiment of the present invention as set forth in claim 2, the polymer matrix is adapted or selected in accordance with a temperature occurring during the manufacturing of printed circuit boards. By the adaptation of the material to process temperatures occurring in the subsequent manufacturing of PCBs, where the material is used, for example, a flowability of the material can be set, such that the material has its ideal flowability during, for example, the lamination process of the PCB. Advantageously, this allows that, for example, during processing at ambient temperature, the material does not flow into small holes, but during the lamination process, where temperatures of approximately 170° C. may occur, the material flows into such small holes.

According to another exemplary embodiment of the present invention as set forth in claim 1, the material has a high flowability at a temperature of approximately 170° C. and has the property that, after being heated, the material may cure. Thus, advantageously, during, for example, the lamination process, the material may fully cure.

According to another exemplary embodiment of the present invention as set forth in claim 4, the polymer matrix is selected from the group consisting of epoxy resin, polyetheretherketon (PEEK) and polyphenylensulfid (PPS).

According to another exemplary embodiment of the present invention as set forth in claims 5 and 6, the material is made available in the form of a layer, wherein each side of the layer may be provided with another layer selected from the group consisting of glass fiber reinforced plastic, copper clad on one or both sides or unclad, prepreg, flex-foil, copper and resin coated copperfoil.

According to other exemplary embodiments of the present invention as set forth in claims 7 and 8, the material is arranged on a carrier and the carrier may be selected from the group consisting of glass fiber reinforced plastic, copper clad on one or both sides or unclad, prepreg, flex-foil, copper and resin coated copperfoil (RCC).

Advantageously, due to the provision of the material on a carrier, the handling of the material before and during the manufacturing of printed circuit boards is made easy.

According to another exemplary embodiment of the present invention as set forth in claim 9, a printed circuit board is provided, comprising a polymer matrix and a soft magnetic powder, wherein the polymer matrix is filled with the soft magnetic powder.

Advantageously, according to this exemplary embodiment of the present invention, a material having soft magnetic properties may be made part of the printed circuit board.

According to another exemplary embodiment of the present invention as set forth in claim 10, the polymer matrix filled with soft magnetic powder is integrated into the printed circuit board.

Advantageously, this may provide for an integral integration of the soft magnetic material, comprising the polymer matrix filled with the soft magnetic powder into the PCB.

According to another exemplary embodiment of the present invention as set forth in claim 11, the printed circuit board further comprises circuit structures forming, together with the polymer matrix filled with soft magnetic powders, an inductive component. Advantageously, this exemplary embodiment of the present invention allows for the complete integral integration of a complete inductive component into a PCB.

Claims 12 and 13 provide for further exemplary embodiments of the printed circuit board according to the present invention.

According to another exemplary embodiment of the present invention as set forth in claim 14, a method of manufacturing printed circuit boards is provided, where a polymer matrix is selected which is suitable for the use with a particular manufacturing process for manufacturing printed circuit boards, where the polymer matrix is to be used. Then, a material is formed by filling the polymer matrix with soft magnetic powder, thus providing a material having soft magnetic properties. Then, the material is applied in the subsequent manufacturing process, for manufacturing printed circuit boards. Advantageously, according to this exemplary embodiment of the present invention, a method is provided allowing for the integration of a soft magnetic material into a PCB.

According to another exemplary embodiment of the present invention as set forth in claim 15, the material forms, together with circuit structures, an inductive component, which is an integral part of the PCB.

It may be seen as the gist of an exemplary embodiment of the present invention that a material is provided comprising a polymer matrix filled with soft magnetic powder. This material is for use in a manufacturing process for manufacturing PCBs. According to an aspect of the present invention, the polymer matrix of the material is selected and/or adapted such that it is compatible with conditions and/or materials used and applied during the subsequent manufacturing of PCBs. According to an aspect of the present invention, for example, the polymer matrix is adapted or selected such that its flowability is adjusted to temperatures occurring during the lamination process. Advantageously, this may allow for the integration of a soft magnetic material into the PCB, such that, for example, complete inductive components may be realized in the PCB, which are an integral part of the PCB.

These and other aspects of the present invention will become apparent from and elucidated with reference to the embodiments described hereinafter.

Exemplary embodiments of the present invention will be described in the following with reference to the following drawings.

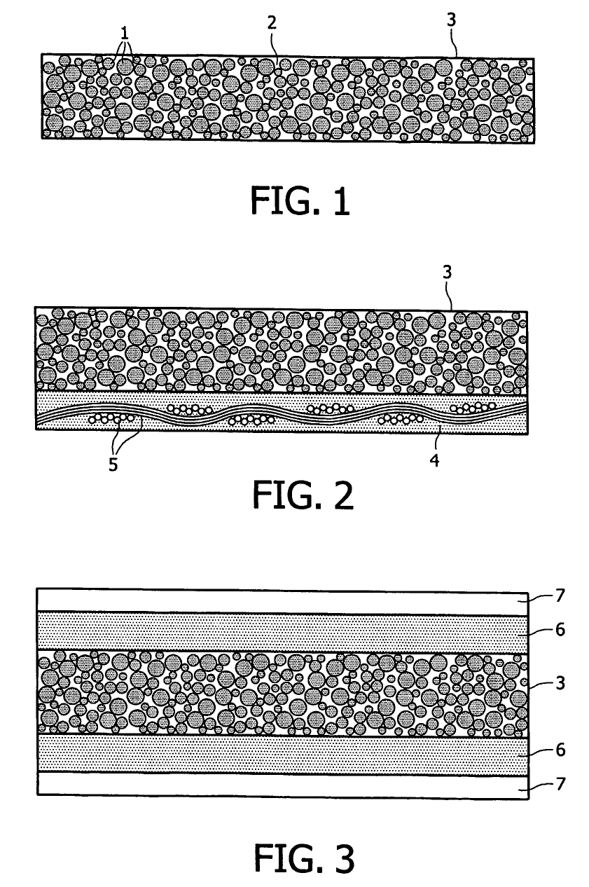

FIG. 1 shows a sectional view of a first exemplary embodiment of the material according to the present invention.

FIG. 2 shows a sectional view of a second exemplary embodiment of the material according to the present invention.

FIG. 3 shows a sectional view of a third exemplary embodiment of the material according to the present invention.

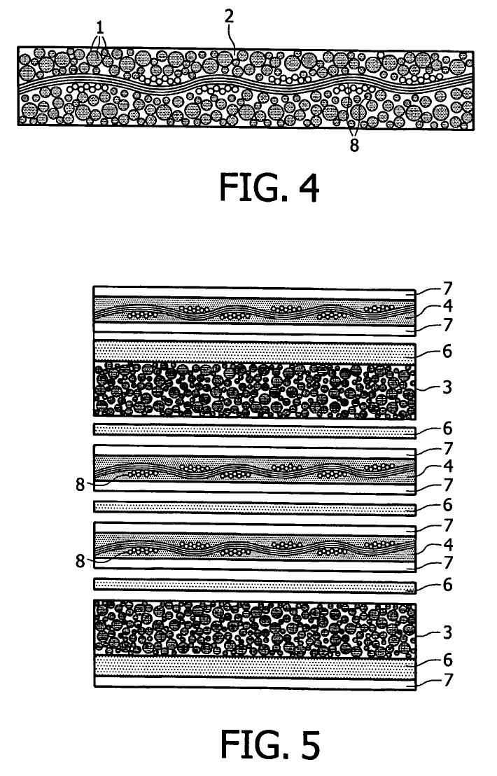

FIG. 4 shows a sectional view of a fourth exemplary embodiment of the material according to the present invention.

FIG. 5 shows a sectional view of layers during a first manufacturing step of manufacturing a PCB according to an exemplary embodiment of the present invention.

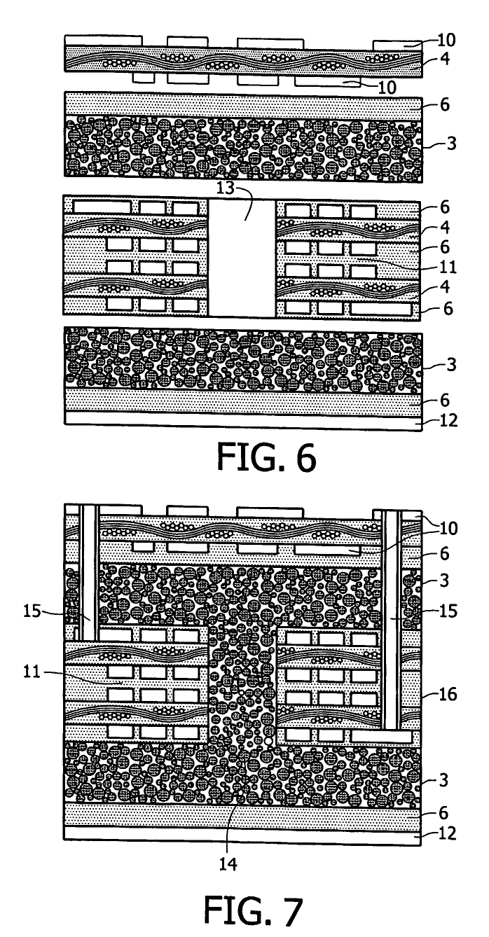

FIG. 6 shows the layers of FIG. 5 in accordance with a second manufacturing step of an exemplary embodiment of a PCB according to an exemplary embodiment of the present invention.

FIG. 7 shows the layers of FIG. 5 in a laminated state forming an exemplary embodiment of a PCB according to the present invention.

In the following description of exemplary embodiments of the present invention, the same reference numerals are used to designate the same or corresponding elements throughout FIGS. 1 to 7.

FIG. 1 is a sectional view of a first exemplary embodiment of a composite material 3 according to the present invention. As may be taken from FIG. 1, the composite material 3 for use in the manufacturing of printed circuit boards, comprises a polymer matrix 2 and a soft magnetic powder, consisting of soft magnetic particles 1 such as ferrite powder particles or iron powder. Also, nickel-iron, μ-metal, amorphous iron, nano-crystalline iron or iron nanoparticles may be used. Furthermore, for power applications, power ferrites having a moderate permeability may be used. This may allow for reduced losses.

Also, for Electro-Magnetic Interference (EMI) applications, EMI-ferrites may be used, having a high permeability. Advantageously, this may allow to control losses in a greater frequency range. Also, for HF-applications, HF-ferrites with small losses but a significantly large frequency range may be used. In the lower frequency range, MnZn ferrites may be used. For higher frequencies (low permeability) NiZn-ferrites may be used. In the high frequency range (GHz), Hexa-ferrites may be used.

According to a preferred embodiment of the present invention, a combination of approximately 30 weight-percent (wt-%) magnesium-zinc-ferrites and of approximately 70 wt-% nickel-zinc-ferrites may be used as ferrite powder particles. Such composite material may then comprise approximately 75 wt-% to 98 wt-% ferrite powder. It may also comprise between approximately 85 wt-% and 92 wt-% ferrite powder. In particular, it may be advantageous to have approximately 88 wt-% ferrite powder and 12 wt-% epoxy resin. A grain size of the soft magnetic powder particles may range from 10 μm to 35 μm up to 80 μm to 110 μm. The form of the particles may be spherical or irregular. A TG value of the polymer matrix 2 (such as of a thermoset) may be above 120° C. These parameters may be selected to control the viscosity during the manufacturing or may also be selected with regard to medical aspects to ensure a medically unproblematic manufacturing.

According to an aspect of the present invention, the composite material 3 is adapted to a subsequent manufacturing process for manufacturing PCBs, where the composite material 3 is used. For example, the composite material 3 or the polymer matrix 2 of the material may be selected, controlled or adapted to temperatures occurring due to the lamination of the PCBs during the subsequent manufacturing of the PCBs. Therefore, the composite material 3 may be selected in a way such that it is free-flowing with a first flowability at approximately room temperature, such that the composite material 3 may easily be applied to, for example, a carrier material of the PCB. Then, the composite material 3 may be controlled such, by way of, for example, the so called b-stage process that it has a second flowability at a temperature occurring, for example, during the lamination process of the PCB. A typical temperature occurring during the lamination is approximately 170° C. The flowability during the lamination process may be much higher than the flowability at room temperature or ambient temperature. By this, it can be ensured that the composite material 3 may be easily applied to the PCB and then, during the lamination, flows into even the smallest holes or cavities in the PCB. Furthermore, the composite material 3 or the polymer matrix 2 may be selected such that it cures during or after the lamination process.

Furthermore, according to an aspect of the present invention, the composite material 3 may, for example, be selected in accordance with materials used during the subsequent manufacturing of PCBs, where the composite material 3 should be used. The polymer matrix 2 may, for example, be an epoxy resin, which, for example, is compatible with FR4 printed circuit boards. However, it is also possible to use or apply other materials such as high temperature thermoplastics, such as polyetheretherketon (PEEK) or polyphenylensulfid

(PPS). Such high temperature thermoplastics are compatible with, for example, flexible polyamide foils, which are often referred to as flex foils.

The composite material 3 depicted in FIG. 1 is preferably provided as a semi-finished product in the form of a thin layer. Preferably, the material is provided in a non-cured state. The thickness of such layers may, for example, be in the range of 1 mm. However, depending on the application and depending on the subsequent manufacturing process for manufacturing PCBs, to which the respective material is adapted, layers with a thickness of less than 100 μm or thick layers having a thickness of a plurality of millimeters may be suitable. The size of such a layer may be in the range of a ¼ m². However, depending on the subsequent manufacturing process, larger or smaller surface areas, ranging from a few cm² to a few m² may be provided. Also, according to an aspect of the present invention, the composite material 3 may be provided as endless band and may be rolled onto a roll. Such a roll may be advantageous, in particular for the further manufacturing of the PCB, since such a roll may be applied to a roll-to-roll process.

FIG. 2 shows a sectional view of a second exemplary embodiment of the composite material 3 according to the present invention. As may be taken from FIG. 2, in order to allow for an easy handling of the material 3, the material 3 may be provided on a carrier 4. Preferably, according to an aspect of the present invention, the carrier is also selected in accordance with the subsequent process for manufacturing the PCB, such that it is compatible with this process. As may be taken from FIG. 2, the carrier 4, which may also be a PCB itself, may include glass fibers 5.

Other materials which may be used as carrier materials are glass fiber reinforced plastics, prepreg, flex-foils, copper and, for example, resin coated copperfoils (RCC).

FIG. 3 shows a sectional view of a third exemplary embodiment of the material according to the present invention. As may be taken from FIG. 3, the material comprises a layer of soft magnetic composite material 3, such as the one depicted, for example, in FIG. 3. This layer is provided on both sides with insulating layers 6. Each of the insulating layers 6 is covered by a copper layer 7.

Advantageously, such copper layers 7 may provide for an electromagnetic shielding (EMI shielding) of components such as inductive components formed with the soft magnetic and material layer 3. According to an aspect of the present invention, the copper layers 7 (which may also be made of other conducting materials, such as aluminum), may include circuit structures. These circuit structures may, together with the soft magnetic and material layer 3, form inductive components. Thus, according to an aspect of the present invention, an inductive component may be formed integrally with the PCB.

A variant of the third exemplary embodiment depicted in FIG. 3 may also comprise a carrier material, such as glass fiber reinforced plastic, prepreg, flex-foil, copper or resin coated copperfoil between the layers depicted in FIG. 3.

Also, a carrier such as the carrier 4 in FIG. 2 may also consist of or comprise a plastic or metal foil, which may be pealed away after or prior to the lamination of the PCB.

FIG. 4 shows a sectional view of a fourth exemplary embodiment of a material according to the present invention. As may be taken from FIG. 4, there may be provided a reinforcement material 8 in the polymer matrix 2 filled with the soft magnetic powder particles 1. Such a reinforcement material 8 may, for example, be a glass fiber material or a similar material. Such reinforcement material 8 may be, homogenously or inhomogenously distributed in the material.

According to an aspect of this fourth exemplary embodiment of the present invention, only a very narrow area of the layer contains the reinforcement material 8. In order to ensure stability, the reinforcement material 8, as depicted in FIG. 4, may be woven such that fibers of the reinforcement material 8 may cross each other. Advantageously, due to the fact that only a very narrow area of the layer is occupied by the reinforcement material 8, the remaining area may be enriched with soft magnetic particles 1, such as ferrite powder.

According to another aspect of this fourth exemplary embodiment of the present invention, even improved magnetic properties may be achieved when the reinforcement material 8 comprises soft magnetic metal fibers. For example, nano-crystalline iron fibers or FeCo fibers having high permeabilities up to over μᵣ10000 and very high saturation flux densities of Bₘₐₓ>1 T may be used. However, it is also possible to use other materials, such as SiFe, which is also referred to as transformer sheet metal.

The first to fourth exemplary embodiments depicted in FIGS. 1 to 4 may be provided as semi-finished products and may be provided to a manufacturer of PCBs in the forms depicted in FIGS. 1 to 4. However, as apparent to the skilled person, each of the first to fourth embodiments depicted in FIGS. 1 to 4 may be provided with suitable circuit structures, thus forming PCBs themselves. Preferably, such circuit structures may be arranged such that they form, together with the soft magnetic material, an inductive component, such as, for example, a coil, a transformer or an electric motor.

FIG. 5 shows a cross-section of individual layers used to form a PCB in accordance with an exemplary embodiment of the present invention. As may be taken from FIG. 5, the PCB to be formed includes eight individual pre-manufactured layer elements, which each may comprise a plurality of layers. The first layer element from the top comprises a plate-like PCB 4 including glass fibers 8. The PCB 4 is covered on each side with a copper layer 7. Each of the copper layers 7 may comprise a circuit structure.

The second layer element from the top includes a soft magnetic composite material 3, such as the one depicted in FIG. 1, covered on one side with an insulating layer 6, such as a dielectric layer. The insulating layer 6 is arranged between the copper layer 7 and the composite material 3.

The third layer element from the top is an insulating layer 6 such as a dielectric layer to be arranged between the material 3 of the second layer element and a copper layer 7 including, for example, circuit structures, on the fourth layer element. As may be taken from FIG. 5, the fourth layer element includes two copper layers 7, which may include circuit structures thereon, which sandwich a PCB 4 with glass fiber fabric. Between the fourth layer element and the sixth layer element there is provided another layer element comprising an insulating layer 6, which may be a dielectric layer. The sixth layer element may have the same configuration as the fourth layer element, including two copper layers 7, which sandwich a PCB 4.

Between the sixth layer element and the eighth layer element there is arranged another insulating layer 6, such as a dielectric layer.

The eighth layer element includes a layer of soft magnetic composite material 3, such as the one depicted in FIG. 1, an insulating layer 6 and a copper layer 7. The insulating layer 6 is arranged between the material 3 and the copper layer 7.

Each of these first to eighth layer elements may be pre-manufactured and may be the starting product for a subsequent manufacturing process of PCBs.

According to the present invention, the first step of manufacturing PCBs from such individual layers is to select the composite material 3 in accordance with the PCB manufacturing process to be used. As mentioned above, the copper layers 7 may be unstructured, but may also comprise pre-manufactured circuit structures.

During the subsequent manufacturing of the PCBs, the individual layers may be etched to form circuit structures and holes may be formed to provide through contacts.

FIG. 6 shows a second stage or step during the manufacturing of the PCB in accordance with the present invention. In particular, FIG. 6 shows a cross-sectional view of the individual layers of the PCB after further processing, in particular, it can be taken from FIG. 6 that the first layer element has been treated such that circuit structures, such as copper conducting paths 10, were formed into the copper layers 7 on the PCB or carrier material 4.

The second layer element remained untreated.

The copper layers 7 on the fourth and sixth layer elements have been structured such that windings 11 were formed, which, after lamination of the individual layer elements, form the windings of the inductive component. Also, it may be taken from FIG. 6 that a hole 13 has been drilled into the laminated third, fourth, fifth, sixth and seventh layer elements.

As may be taken from FIG. 6, the eighth layer element remained untreated. However, in accordance with the function of the copper layer 7, the copper layer 7 may now be referred to as shielding layer 12.

FIG. 7 shows a cross-sectional view of the finished PCB according to an exemplary embodiment of the present invention, manufactured by using the soft magnetic composite material 3 in accordance with an exemplary embodiment of the present invention, after lamination and through plating.

During lamination, the PCB was heated up to a temperature of approximately 170° C. As mentioned above, the soft magnetic composite material 3, including the polymer matrix 2 and the soft magnetic particles 1, was selected such that it has a high flowability at the temperature occurring during the lamination process. Due to this, as may be taken from FIG. 7, during the lamination, the composite material 3 was flowing into the hole 13, such that it filled the hole 13 with the composite material 3, forming a soft magnetic through connection. Reference numeral 14 designates this through connection.

As may be taken from FIG. 7, a PCB is provided, including an integrated inductive component formed by the material 3 and the windings 11. According to the present invention, this inductive component is integrally integrated into the PCB.

Accordingly, as shown in FIGS. 5 to 7, a method is provided for manufacturing printed circuit boards according to an exemplary embodiment of the present invention, where a polymer matrix for the material 3 is selected such that it is suitable or compatible with the subsequent manufacturing process. In particular, it is selected such that it has the ideal required flowability at the lamination temperature of the PCB during the subsequent manufacturing process. The composite material 3 contains a polymer matrix 2 filled with soft magnetic powder. Then, as may be taken from FIGS. 5 to 7, the material is applied during the manufacturing process in a way such that the composite material 3 forms, together with circuit structures, an inductive component such as a coil, transformer, or even an electric motor.

As may be taken from FIGS. 5 to 7, two soft magnetic material layers 3 are used. There is the second layer element comprising the soft magnetic composite material layer 3, which is covered on one side with an insulation layer 6, serving as carrier and insulation layer to other layers. The other second layer element including the soft magnetic composite material 3 is the eighth layer element which includes an insulation layer 6 and a copper layer 12, acting as shielding layers to electromagnetically shield the PCB.

Furthermore, as may be taken in particular from a comparison of FIGS. 6 and 7, during the lamination process, the soft magnetic composite material 3 flows through the hole 13 into the middle layer elements of the PCB, such that a closed magnetic circuit is formed. Together with the circuit elements 11, the closed circuit magnetic circle forms the inductive component.

As may be taken from FIG. 7, at the end, the PCB may be provided with through contacts 15 allowing to contact inner layers. For this, holes may be drilled which are filled with an isolation material such as plastic. Then, holes may be drilled in the insulation material which are filled with conducting material. Thus, insulated trough contacts 15 may be provided. Advantageously, this may provide for an insulation between the trough contacts 15 and soft magnetic composite material.

1. Material for use in the manufacturing of printed circuit boards, the material comprising: a polymer matrix; and a soft magnetic powder; wherein the polymer matrix is filled with the soft magnetic powder; and wherein the polymer matrix is such that it is compatible with at least one of materials comprised in printed circuit boards and processes used for the manufacturing of printed circuit boards.

2. The material of claim 1, wherein the polymer matrix is adapted in accordance with a temperature occurring during the manufacturing of printed circuit boards.

3. The material of claim 1, wherein the material has a first flowability at approximately room temperature; wherein the material has a second flowability at a lamination temperature occurring during a lamination in the manufacturing of printed circuit boards, the first flowability being smaller than the second flowability; and wherein the material is adapted to cure one of after and during lamination.

4. The material of claim 1, wherein the polymer matrix is selected from the group consisting of thermosetting resin, polyetheretherketon and polyphenylensulfid.

5. The material of claim 1, wherein the material is in the form of a layer.

6. The material of claim 5, wherein each side of the layer is provided with another layer selected from the group consisting of glass fiber reinforced copper-clad or unclad plastic, prepreg, flex-foil, copper and resin coated copperfoil.

7. The material of claim 1, wherein the material is arranged on a carrier.

8. The material of claim 7, wherein the carrier is selected from the group consisting of glass fiber reinforced copper-clad or unclad plastic, prepreg, flex-foil, copper and resin coated copperfoil.

9. Printed circuit board, comprising: a polymer matrix; and a soft magnetic powder; wherein the polymer matrix is filled with the soft magnetic powder.

10. The printed circuit board of claim 9, wherein the polymer matrix filled with soft magnetic powder is integrated in the printed circuit board.

11. The printed circuit board of claim 9, further comprising: circuit structures of a conducting material; wherein the polymer matrix filled with soft magnetic powder forms, together with the circuit structures, an inductive component.

12. The printed circuit board of claim 11, wherein the inductive component is one of a coil, transformer or electric motor.

13. The printed circuit board of claim 9, wherein the polymer matrix filled with soft magnetic powder forms a layer, further comprising: a copper layer including circuit structures; and a carrier layer.

14. Method of manufacturing printed circuit boards, the method comprising the step of: selecting a polymer matrix suitable for the use with a manufacturing process for manufacturing printed circuit boards; forming a material by filling the polymer matrix with soft magnetic powder; and applying the material in the manufacturing process for manufacturing printed circuit boards.

15. Method of claim 14, further comprising the steps of: forming circuit structures at least one of on and in the printed circuit board; wherein the material forms, together with the circuit structures an inductive component.
